(19) United States
(12) Patent Application Publication
(10) Pub. No.: US 2005/0205686 A1
(43) Pub. Date: Sep. 22, 2005

(54) Fuel injecton valve

(76) Inventors: Fevzi Yildirim, Gerlingen (DE); Michael Huebel, Gerlingen (DE)

Correspondence Address: KENYON & KENYON, ONE BROADWAY, NEW YORK, NY, 10004, US

(21) Appl. No.: 10/508,758

(22) PCT Filed: Jan. 29, 2003
(86) PCT No.: PCT/DE03/00237

§ 371 Date: May 11, 2005

(30) Foreign Application Priority Data
Mar. 27, 2002 (DE) 102 13 858.3

(51) Int. Cl. B05B 1/08

(52) U.S. Cl. 239/102.2; 239/584

(57) ABSTRACT

A fuel injector, in particular an injector for fuel injection systems of internal combustion engines, may include a piezoelectric or magnetostrictive actuator, which, via an hydraulic coupler, actuates a valve-closure member formed on a valve needle, the valve-closure member cooperating with a valve-seat surface to form a sealing seat. The hydraulic coupler may have a master piston and a slave piston. A coupler gap formed between the master piston and the slave piston may be dimensioned such that it is closed in the cold state of the fuel injector and opens by a temperature-related linear deformation of the actuator as the temperature of the fuel injector increases.

### FIELD OF THE INVENTION

The present invention is directed to a fuel injector having a coupling gap.

### BACKGROUND INFORMATION

In European Patent Document No. 0 477 400, an hydraulic coupler for a piezoelectric actuator is apparently discussed, in which the actuator transmits a lifting force to a master (transmitter) piston. The master piston is in force-locking connection to a guide cylinder for a slave (receiving) piston. The slave piston, the guide cylinder and the master piston sealing the guide cylinder form an hydraulic chamber. A spring by which the master piston and the slave piston are pressed apart is arranged in the hydraulic chamber. Surrounding an end section of the guide cylinder and the slave piston is a rubber sleeve, which seals a supply chamber for a viscous hydraulic fluid from a fuel chamber. The viscosity of the hydraulic fluid is adapted to the ring gap between the slave piston and the guide cylinder.

The slave piston may mechanically transmit a lifting movement to a valve needle, for instance. When the actuator transmits a lifting movement to the master piston and the guide cylinder, this lifting movement is transmitted to the slave piston by the pressure of the hydraulic fluid in the hydraulic chamber, due to the fact that the hydraulic fluid in the hydraulic chamber is not compressible and during the short duration of a lift only a small portion of the hydraulic fluid is able to escape, through the ring gap, into the storage chamber formed by the rubber sleeve. In the rest phase, when the actuator is not exerting any compressive force on the master piston, the spring pushes the slave piston out of the guide cylinder and, due to the generated vacuum pressure, the hydraulic fluid enters and refills the hydraulic chamber via the ring gap. In this way, the coupler automatically adapts to linear deformations and pressure-related expansions of a fuel injector.

A possible disadvantage in the coupler known from European Patent No. 0 477 400 is that the sealing by a rubber sleeve, which is may be pressed against the end section of the guide cylinder and against the slave piston by two clamping rings, may not be fully ensured in the long term. The highly viscous hydraulic fluid and the fuel may mix and the coupler possibly break down. When fuel, such as gasoline, reaches the interior of the coupler, a loss of function may occur since this fluid, due to the low viscosity of the gasoline, may flow too rapidly through the ring gap and no pressure is able to be generated in the pressure chamber during the lift duration.

Furthermore, a fuel injector having a piezoactuator, which is connected to a pressure piston having a large surface, is apparently discussed in German Patent No. 43 06 073. This pressure piston is prestressed with respect to the piezoelectric actuator by a disk spring that is braced against the valve body of a fuel injector. The pressure piston is guided in a bore of the valve body and has a central bore hole in which a slave piston is guided, the slave piston being connected to a valve needle. Situated in the bore of the pressure piston, between the base of the bore and the slave piston, is a spring, which may provide an initial stress to the slave piston in the direction of a valve seat, pushing the slave piston out of the bore. The fuel injector has a valve needle that opens toward the inside. A pressure chamber is located between the fuel injector body and the pressure piston and the opposite side of the slave piston. The pressure chamber is connected to the actuator chamber via the annular gap between the slave piston and the pressure piston, the bore in the pressure piston and a connecting bore. The actuator chamber is used as a supply chamber for an hydraulic fluid. When the piezoactuator is actuated by a voltage being applied, the pressure piston is displaced in the direction of the valve seat. Due to the increased pressure of the hydraulic fluid in the pressure chamber, the slave piston is pressed into the bore, into the pressure piston, counter to the pressure piston's direction of movement, thereby lifting a valve needle off from the valve seat.

A possible disadvantage in the fuel injector known from German Patent No. 43 06 073 is that it may provide no solution for an outwardly opening fuel injector. Furthermore, it may be disadvantageous that no devices are provided for the rapid refilling of the pressure chamber after the return to the rest position. Finally, the design consists of a plurality of parts and is complex since a pressure piston guided in the fuel injector in a precise bore may in turn require a precisely worked bore for the slave piston.

### SUMMARY OF THE INVENTION

The fuel injector according to an exemplary embodiment of the present invention has the advantage that the coupler gap of the hydraulic coupler may be closed in the cold state of the internal combustion engine, a result of the actuator being made of a material having a negative temperature expansion coefficient. In the cold state, the valve needle may therefore be actuated directly by the actuator, so that the opening time of the fuel injector does not depend on the leakage losses of the hydraulic coupler.

It may be advantageous that the hydraulic coupler penetrates a sleeve, which is braced against a disk connected to the slave piston. The sleeve may have a shoulder from which the slave piston projects, in this way delimiting the lift of the master piston.

The overall lift of the valve needle may be made up of partial lifts, which may be advantageously activated by the thermal linear deformation of the actuator as a function of the operating temperature of the internal combustion engine.

### BRIEF DESCRIPTION OF THE DRAWINGS

FIG. 1 shows is a schematic sectional view through an exemplary embodiment of a fuel injector configured according to the present invention, in the region of the actuator and coupler.

FIG. 2 is a block diagram of a hydraulic coupler according to an exemplary embodiment of the present invention.

### DETAILED DESCRIPTION

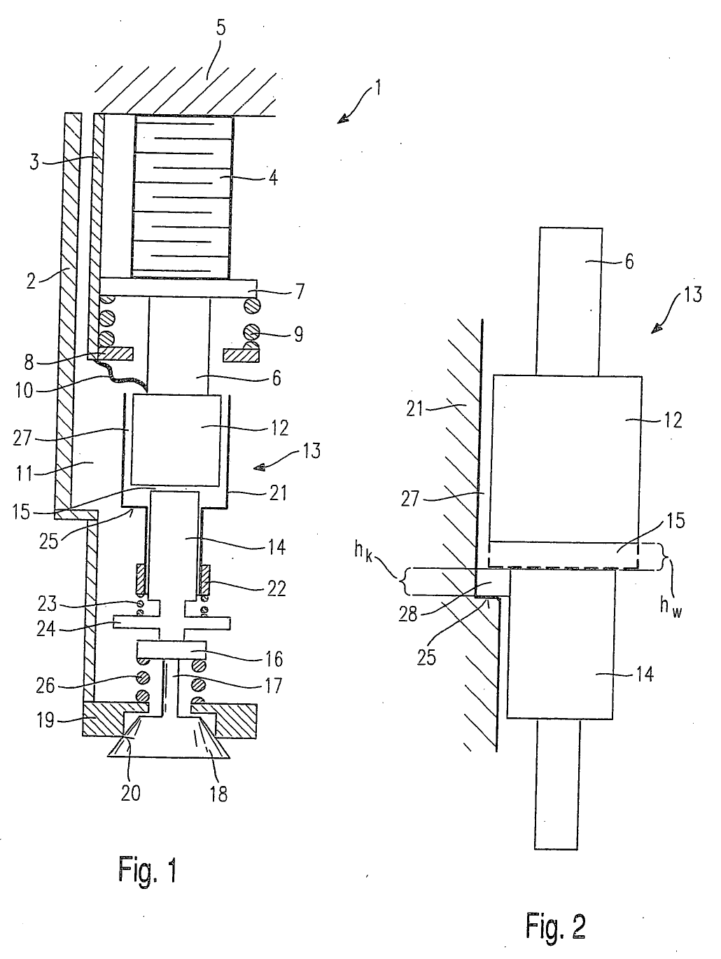

FIG. 1 shows a schematized representation of an exemplary embodiment of a fuel injector 1 configured according to an exemplary embodiment of the present invention. Fuel injector 1 may be suited, in particular, for the direct injection of fuel into the combustion chamber of a mixture-compressing internal combustion engine having external ignition.

Fuel injector 1 has a housing 2 in which an actuator 4 is disposed, which is encapsulated in an actuator cartridge 3. Actuator 4 may be designed, for example, as piezoelectric or magnetostrictive actuator 4. On the intake side, actuator 4 is braced against a housing component 5, while on the discharge side it abuts against a piston-shaped actuating element 6. Actuator 4 is prestressed by a compression spring 9 disposed between a shoulder 7 of actuating element 6 and a supporting disk 8. A seal 10, which may be in the form of a corrugated tube, for instance, seals actuator cartridge 3 from an interior chamber 11 of fuel injector 1. In this way, actuator 4 may be protected, both mechanically and chemically, from the fuel flowing through fuel injector 1.

In the discharge direction, actuating element 6 is supported on a master piston 12 of an hydraulic coupler 13, a coupler gap 15 being formed between master piston 12 and slave piston 14. Slave piston 14 is braced against an additional supporting disk 16 at whose other side a valve needle 17 is disposed. A valve-closure member 18, which forms a sealing seat together with a valve-seat member 19 formed on valve-seat surface 20, is provided at the valve needle 17. Disposed between supporting disk 16 and valve-seat member 19 is a restoring spring 26, which provides valve needle 17 with an initial stress in such a way that fuel injector 1 is kept closed in the deenergized state of actuator 4.

Hydraulic coupler 13 penetrates a sleeve 21, which, via a flange 22 and a spring 23, is braced against a disk 24, which is integrally formed with slave piston 14 or is connected to it by suitable means. Sleeve 21 may thus be disposed in a displaceable manner both with respect to hydraulic coupler 13 and with respect to housing 2 of fuel injector 1.

According to an exemplary embodiment of the present invention, the hydraulic coupler 13 having sleeve 21 may be designed such that both a cold-start phase of the internal combustion engine, in which the components are not yet subjected to thermal linear deformation, and also a continuous operation in which the internal combustion engine is warm, are able to be carried out with satisfactory opening times.

If the internal combustion engine is started while cold, it may be necessary to realize up to twenty-fold full-load quantities at very low temperature, which may be as low as −40 degrees Celsius, and low pressures of approximately 0.5 MPa. The low system pressure and the high full-load quantities may result in trigger times of actuator 4 that may be considerably above the trigger times of a warm internal combustion engine. The leakage losses in hydraulic coupler 13 may be so substantial in this case that, due to the pressure loss, valve needle 17 may drop back into the sealing seat prematurely, so that it may therefore be impossible to spray-discharge the requested fuel quantity.

If coupler gap 15 between master piston 12 and slave piston 14 of hydraulic coupler 13 is adjusted according to an exemplary embodiment of the present invention and, given a predefined width of leakage gaps 27 of hydraulic coupler 13, it may therefore be possible to ensure that hydraulic coupler does not idle even when the opening times of fuel injector 1 are long, and that fuel injector 1 is able to be kept open. A detailed representation of the relevant components may be inferred from the following description in connection with FIG. 2.

When the internal combustion engine is cold, coupler gap 15 is closed, as shown in FIG. 2 by the dotted line. This is the result of the fact that actuator 4 is made of a piezoelectric or magnetostrictive material that contracts when the temperature rises and expands when the temperature drops. If actuator 4 is energized, it expands in a lift direction, so that valve needle 17 is directly activated by actuator 4. By the direct activation of valve needle 17 via actuator 4, given a bridged coupler 13, its leakage losses are unable to influence the opening times of fuel injector 1, so that it may be retained in the open position for as long as desired, solely as a function of the trigger time of actuator 4. In this case, the lift is h_{ges}=hₖ, partial lift hₖ being the width of a residual gap 28 between master piston 12 and shoulder 25 of sleeve 21 given a cold internal combustion engine.

If the internal combustion engine is warmed up, actuator 4, among others, is subject to thermal linear deformation, which has the result that coupler gap 15 between master piston 12 and slave piston 14 is opened, which is illustrated in FIG. 2 by the solid-line contour of master piston 12, so that valve needle 17 is activated indirectly via hydraulic coupler 13, the stroke being geared up. In this case, the stroke is h_{ges}=h_{w}+hₖ, h_{w} being the width of coupler gap 15 between master piston 12 and receiver piston 14. Axial width h_{w} of residual gap 28 is always larger, or at the most equal to, maximum lift h_{ges} of actuator 4. Width h_{w} of coupler gap 15 h_{w} is preferably 25 to 50 μm at 20 degrees Celsius and a fuel pressure of 0.5 MPa.

The present invention may not be limited to the exemplary embodiment shown and may also be suitable for magnetostrictive actuators 4 and for any other configurations of fuel injectors 1.

1-8. (canceled)

9. A fuel injector, comprising:
an actuator, the actuator being one of a piezoelectric actuator and a magnetostrictive actuator;
an hydraulic coupler including a master piston and a slave piston; and
a valve needle and a valve-closure member provided on the valve needle, the valve-closure member cooperating with a valve-seat surface to form a valve-sealing seat;
wherein the actuator actuates via the hydraulic coupler the valve-closure member provided on the valve needle, and wherein a coupler gap formed between the master piston and the slave piston is adapted to close in a cold state of the fuel injector and adapted to open via a temperature-related linear deformation of the actuator as a temperature of the fuel injector increases.

10. The fuel injector of claim 9, wherein a gap width of the coupler gap is between about 25 μm and 50 μm at a temperature of about 20 degrees Celsius and a fuel pressure of about 0.5 MPa.

11. The fuel injector of claim 9, wherein the hydraulic coupler penetrates a sleeve, the sleeve abutting against a spring via a flange connected to the sleeve.

12. The fuel injector of claim 11, wherein the spring is braced against a disk connected to the slave piston by force locking.

13. The fuel injector of claim 11, wherein the sleeve has a shoulder, and wherein the slave piston projects axially beyond the shoulder by a predetermined length hₖ.

14. The fuel injector of claim 13, wherein an overall lift of the actuator corresponds to the predetermined length hₖ in the cold state of the fuel injector.

15. The fuel injector of claim 13, wherein an overall lift of the actuator is substantially equal to the sum of an axial width of the coupler gap formed between the master piston and the slave piston, and the predetermined length hₖ, in a warm state of the fuel injector.

16. The fuel injector of claim 13, wherein the predetermined length hₖ is between about 40 μm and about 70 μm.

17. The fuel injector of claim 15, wherein the predetermined length hₖ is between about 40 μm and about 70 μm.
